(19) United States
(12) Patent Application Publication
(10) Pub. No.: US 2004/0031018 A1
(43) Pub. Date: Feb. 12, 2004

(54) Modular computer system and related method

(76) Inventor: Emmanuel Marty, Montpellier (FR)

Correspondence Address: Blakely Sokoloff Taylor & Zafman, 7th Floor, 12400 Wilshire Boulevard, Los Angeles, CA, 90025-1026, US

(21) Appl. No.: 10/311,526

(22) PCT Filed: Jun. 14, 2001
(86) PCT No.: PCT/FR01/01853

(30) Foreign Application Priority Data
Jun. 16, 2000 (FR) 00/07754

(51) Int. Cl. G06F 9/44

(52) U.S. Cl. 717/120

(57) ABSTRACT

The invention relates to a process for developing computer projects intended to be implemented by a computer system, process comprising a phase of functional analysis with a view to cataloguing the functionalities which are to be catered for, a phase of creating components of the project with the aid of computer means so as to fulfil the said functionalities, a phase of declaration on the same system of the components created during the creation phase, and a phase of loading the said components into a memory area of the system for their implementation by the system,

characterized in that:

during the components creation phase, each functionality is completely fulfilled by the component associated therewith,

during the components declaration phase, each component created is declared to a system loading component, and

during the components loading phase, there are provided means for, in association with each functionality requested by a loaded component, automatically searching for a component offering the said functionality.

### INTRODUCTION

The present invention relates in a general manner to software systems which allow users to interact with computer hardware.

More precisely, the invention relates to a software system comprising an operating system offering qualities of flexibility and of speed of execution which are not conceivable even with the most powerful present-day operating systems.

The invention also relates to a process associated with such a system.

Also, as will be seen, the invention applies advantageously (but not limitingly) to the development of applications associated with on-board computer systems.

It is recalled that the operating system is an essential element of any software system, of which it constitutes the part which interacts directly with the hardware constituent of a computer system.

Numerous operating systems are already known which allow development teams to create applications and allow end users to implement these applications.

The existing operating systems may be schematically split up into two main families.

Monolithic Architectures

The first family consists of monolithic architecture operating systems. Such systems constitute a single software set, which comprises three main layers:

a so-called bottom layer which corresponds to the kernel of the system. The kernel can be defined as a passive and privileged code set permanently loaded into the memory of the system and capable of being used by all the application packages.

Its essential mission is to regulate the use of the shared resources of the system (memory, processor, peripheral). To fulfil this mission, the kernel caters for certain important functionalities including:

the management of the memory (distribution of memory resources between the applications as a function of their requests, etc.),

the management of the procedures (scheduling, management of access to the processor, multitask management, etc.),

the management of the drivers of peripherals,

the management of files (name, address, etc.),

the management of users (access, profiles, etc.).

a so-called top layer dedicated to the applications, and with which the users can interact in order to input instructions into the system and to input requests destined for the kernel,

an intermediate level of so-called “libraries”, which is sometimes regarded as a layer and in which the recurrent functionalities are gathered together so as to allow fast implementation thereof.

Such a monolithic architecture is represented schematically in FIG. 1 appended to the present text, which shows the centralized and hierarchical arrangement of the layers K (kernel), L (libraries) and A (applications).

The definition of “layers” makes it possible to hierarchize the communications between the elements of the operating system, the bottom-most layers being defined as “privileged” layers which can be called by higher-level layers.

The layers are thus classes of software elements which share the same privileges. Also, a privilege can be defined as the ability to use certain resources of the computer system (hardware resource or software resource).

As has been stated, a system built according to such a monolithic architecture constitutes a single software set, which is “blockwise” compilable.

An advantage of this configuration is that the systems are generally stable and fast.

However, such operating systems exhibit significant limitations in terms of flexibility and upgradability of the system.

Indeed, a modification in the kernel systematically involves a complete recompilation of the kernel. For each modification, it is thus necessary to undertake total acceptance of the system again.

Also, this inflexibility of the system is detrimental since upgrades of the system are rendered cumbersome and complex, and its maintenance expensive. Moreover, the system may become unstable owing to successive “add-ons”.

Furthermore, in the case of on-board computer systems (that is to say where at least a part is intended to be integrated into mobile hardware such as a vehicle, a portable telephone, etc.), this inflexibility may show itself to be extremely detrimental, since it also makes it necessary to fix a certain number of characteristics of the computer system a priori (such as the fact that the speed of execution, or the size of the memory, etc. is privileged).

In fact, the diversity of on-board applications often confronts the programmers with varied requirements of the associated computer systems, and it would be advantageous to be able to freely define and upgrade the main characteristics of the system.

Thus, by reason of the drawbacks alluded to hereinabove and stemming mainly from the inflexibility of the monolithic operating systems, this monolithic architecture is essentially intended for applications requiring no significant upgrading of software or of hardware, and it is poorly suited to on-board systems.

Micro-Kernel Architectures

To attempt to alleviate this limitation, a second architecture family has been devised for operating systems. These are systems of the micro-kernel type, such as those represented in FIG. 2.

This figure shows that the micro-kernel systems are, in the manner of monolithic systems, made up of concentric layers surrounding a central kernel which constitutes the “core” of the operating system.

The kernel element MK is here reduced to a “micro-kernel” which fulfils only the essential functionalities required for the operation of the system, namely:

the management of the memory,

the management of the procedures, at least as regards the so-called low-level procedures—concerned with the switching of tasks. It is pointed out that certain micro-kernel systems manage the high-level procedures with the aid of a server, whilst others manage them by means of the micro-kernel itself,

the management of ports (mailboxes) and the passing of messages,

the arbitration of the allocating of hardware resources between the various drivers (a driver being defined as a program which controls the operation of a card or of any peripheral).

The other functionalities traditionally fulfilled by the kernels of monolithic systems are fulfilled by servers S. These servers form an intermediate layer between the upper layer of applications A and the layer L of libraries which directly surround the micro-kernel MK. They take priority over the applications A.

Such a micro-kernel architecture makes it possible to upgrade the operating system without having to recompile the entire system; this second family of operating systems thus permits a certain flexibility as compared with monolithic systems.

However, the architectures of this family are still constructed in successive layers about a central kernel, and all the communication exchanges internal to the operating system must necessarily pass through the micro-kernel.

In fact, the passing of the communications through the successive layers of the system, which are more numerous than in the case of monolithic systems, gives rise to additional processing and slows down the overall operation of the system.

Also, it is consequently necessary to optimize these communication exchanges for any new development of the system, thereby complicating the work of the programmers.

It is therefore apparent that the micro-kernel systems, although they afford additional flexibility as compared with monolithic systems, are associated with lengthier processing operations and represent only an imperfect solution.

Additional Comment Regarding Existing Architectures

Moreover, the present-day systems (monolithic and micro-kernel) are all centred on a kernel element around which successive layers are hierarchized as a function of predetermined access privileges.

Indeed in all these systems, each program is systematically associated with a given layer according to an immutable typology inherent to the system itself, so that this program will systematically be accompanied by a level of privileges beyond the control of the programmers, thereby constituting a first drawback common to existing systems.

Thus, the programs may for example be:

a “kernel” or “supervisor” or “system” code (the privileged code which manages the interaction with the hardware),

a “library” element of passive functionalities (mathematical, video decompression, etc.),

an application package code.

These various types of code often correspond to different file formats, and are managed differently by different elements of the operating systems.

Also, it is not then possible to display with a single tool all the programs installed in the system; likewise it is generally not possible during the operation of the system to replace the “kernel” parts, which form an opaque and indivisible block.

It follows that different tools must be used to create and debug these various types of code, thereby complicating the development operations in all cases; this constitutes a second drawback common to existing systems.

Also, it is understood that the kernel of existing systems constitutes the absolute centre of the system. This kernel has a special status by dint of its level of privileges; it constitutes the least portable part of the system and cannot be modified simply.

Moreover, another characteristic common to existing software systems is that their design has been performed with:

a phase of functional analysis which has made it possible to describe the system in terms of functionalities to be fulfilled, thereby constituting a very intuitive and immediately intelligible descriptive level,

followed by a writing and a compilation of programs during which this level of intelligibility and of readability is adversely altered, the programs constituting opaque sets whose manner of operation is predetermined.

The programs of these systems operate on request as “automata”, and the kernel merely works in reaction as a function of the needs expressed by the applications.

It is thus apparent that the kernel, although it tailors the resources and can use optimization functions to improve the overall operation of the system, always works in reaction downstream with respect to the needs expressed by the applications. This constitutes another essential limitation of existing systems.

As will be seen, in the case of the invention on the other hand, the manner of operation of all the components of the system is integrated and the functional links established during the functional analysis phase are preserved in the architecture of the system.

Thus, relative to a known system such as that represented by the Java language (registered trade mark), a description of which will be found in the document “Introduction to programming using Java”, Version 3.0, summer 2000” by D. J. ECK—Department of mathematics and computer science, Hobart and William Smith College, Geneva, N.Y., US 24/05/2000, accessible on Mar. 7, 2001 at the Internet address http://math.hws.edu/eck/csl24/downloads/Javanotes3.pdf>, it would be advantageous to offer a degree of additional flexibility in the establishing of relations between the entities.

The term “entity” should be understood in the case of known languages (Java for example) to mean the objects and classes which can be deployed.

In the case of the Java language, in fact, if a given entity can actually call other entities which are required for its operation, the programmer must necessarily explicitly specify which entities should be loaded into the random access memory of the system to allow the said given calling entity to operate properly.

It is thus apparent that this type of known language, although it actually offers some flexibility related to an object architecture, nevertheless compels specific entities to be chosen right from the design, thereby greatly limiting the flexibility of the system.

Furthermore, such a known system does not return any error message during loading operations, so that it is possible that a defective entity or one which is incapable of fulfilling its role might be loaded into the system. Also, the deficiency of the said entity will be noted only during the overall operation of the system, or during test operations which will then have to be scheduled specially.

Aims of the Invention

The main aim of the invention is to propose an operating system offering qualities of flexibility and of speed of execution which are not conceivable even with the most powerful present-day operating systems.

Another aim of the invention is to propose a software system which furthermore makes it possible to overcome the drawbacks alluded to hereinabove with regard to all existing systems.

Yet another aim of the invention is to provide a software solution tailored to the constraints inherent in the design of on-board systems.

In order to achieve these aims, the invention proposes a process for developing computer projects intended to be implemented by a computer system, process comprising a phase of functional analysis with a view to cataloguing the functionalities which are to be catered for, a phase of creating components of the project with the aid of computer means so as to fulfil the said functionalities, a phase of declaration on the same system of the components created during the creation phase, and a phase of loading the said components into a memory area of the system for their implementation by the system,

characterized in that:

during the components creation phase, each functionality is completely fulfilled by the component associated therewith,

during the components declaration phase, each component created is declared to a system loading component, and

during the components loading phase, there are provided means for, in association with each functionality requested by a loaded component, automatically searching for a component offering the said functionality.

Preferred but nonlimiting aspects of the process according to the invention are the following:

the said automatic search is performed while taking a condition into account,

the said condition is expressed as a function of criteria expressed as a function of properties associated individually with each component,

during the creation of a component, the following steps are carried out:

creation of an interface source file of the component, with a view to constituting an “interface” part of the component,

creation of at least one code source file making it possible to realize the functionality of the component, with a view to constituting an “implementation” part of the component,

each code source file created with a view to constituting an “implementation” part of the component can be formulated in any programming language,

each component can fulfil the functionality associated therewith by deploying software and/or hardware means,

the interface file of each component comprises a description of the functionality fulfilled by the said component, independent of the manner in which this functionality is fulfilled by the component,

the interface file also comprises a description of the functionalities that the component needs to import from other components in order to fulfil its own functionality,

each component can be dynamically replaced by another component which exports the same functionality,

the said replacement deploys the following steps:

saving of the current state of the component to be replaced,

loading and initialization of the new component,

transmission of the current state of the component to be replaced to the new component,

establishment of a communication channel between the component calling the functionality and the new component,

unloading of the component to be replaced,

if the loading or the initialization of the new component is not performed correctly, means are provided for returning an error message,

during the creation of a component, the following steps are also carried out:

creation of a makefile in which are specified:

the language(s) used for the source file(s) created during the code source file(s) creation step,

the code source file(s) corresponding to the “implementation” part of the component,

creation of a prototype of the component,

editing of links between the “interface” part and the “implementation” part of the component, so as to generate an executable component prototype,

deployment of the makefile so as to compile the component individually, and constitute a respective object file for the interface source file of the “interface” part of the component as well as for the or each code source file of the “implementation” part of the component,

encapsulation of the object files created during the preceding step into a single executable module,

during the creation of the prototype of a component, a prototype comprising:

an object interface resulting from the compilation of the interface source file of the component,

a prototype object file in respect of each code source file of the “implementation” part of the component,

is created,

during the compilation of the interface source file of the component, there is carried out:

the analysis and the verification of the consistency of the source file of the interface,

the translation of the source file of the interface into binary data,

the automatic generation of at least one file so as to call the functionalities which are to be imported by the component,

after the step of editing links between the “interface” part and the “implementation” part of the component so as to generate an executable component prototype, an automatic integrity testing step is carried out during which one verifies whether the project is consistent and closed,

during the automatic integrity test, for each functionality required in the project, there is an automatic search, from among a list of accessible components, for a component which fulfils the said functionality,

in the case where several components fulfilling the requested functionality are identified, a particular component can be chosen from among these components,

in the case where the integrity test reveals that the project is not correctly closed, an error message is issued indicating the inconsistencies so as to be able to modify certain components and/or add some,

for each component loaded into the system, the description of the functionalities that the component needs to import from other components so as to fulfil its own functionality is permanently accessible to the said means of automatic component search,

during the encapsulation of the object files created during the preceding step into a single executable module, one verifies that all the functionalities supplied by the various interface parts of the project have actually been described fully in an associated source file and have been compiled,

the process comprises the storage in a random access memory area of the system of a map of the components loaded into the system,

the said map is intended to be consulted when a calling component calls a functionality, so as to determine whether a component of the said map is able to supply the functionality called up,

it is the said means of automatic component search which are able to consult the said map,

the said map is updated in real time during the operation of the system, as a function of the components loaded into the system,

each component can be associated with a level of privileges which conditions the possibilities of access of the component to other components, as a function of the respective levels of privileges of the said other components,

means are provided for automatically unloading each component where the functionality which it offers is no longer necessary for the operation of the computer projects,

the said means comprise a usage counter for each component,

the said counter counts the number of components which import a functionality of the component with which the counter is associated, and the said component is unloaded as soon as its usage counter has decreased to zero,

there are provided means for automatically freeing the resources used by the said unloaded component.

### INTRODUCTION OF THE FIGURES

Other aspects, aims and advantages of the system according to the invention will become better apparent on reading the following description of an embodiment of the invention, given with reference to the appended drawings in which, apart from FIGS. 1 and 2 which have already been commented on:

FIGS. 3a to 3c are three schematic representations of an operating system according to the invention,

FIG. 4 is a schematic representation of a component of the system according to the invention,

FIG. 5 is a schematic representation of the steps for formulating such a component,

FIG. 6 is a logic chart illustrating the creation and deployment of a component of an operating system according to the invention,

FIG. 7 represents the mode of apportioning and of loading the software components of the system according to the invention,

FIG. 8 illustrates the reduction in memory consumption during the dynamic loading and unloading of components of a system according to the invention,

FIG. 9 is a logic chart illustrating the dynamic replacement of a component in a system according to the invention,

FIGS. 10a, 10b and 10c are three maps of the components loaded into a system according to the invention. FIG. 10a corresponding to a minimal configuration in which only the components strictly necessary for the initial operation of a system according to the invention are loaded. FIG. 10b corresponds to a basic configuration which furthermore allows multi-thread management. FIG. 10c corresponds to an enhanced version of a system according to the invention.

### GENERAL INTRODUCTION TO THE SYSTEM

It has been stated that existing systems, whether they be monolithic or micro-kernel, systematically differentiate the programs as a function of the system layer with which they are associated.

The system according to the invention does not differentiate the programs in this way. On the contrary, in the case of the invention, the operating system consists entirely of non-hierarchical components. Thus, according to an original characteristic, the system according to the invention does not exhibit a layered structure.

Also, although the programmer of a software system retains in the case of the invention the possibility of associating a particular level of privileges with each component of the system so as to communicate with the other components (this level of privileges possibly corresponding to those conventionally used in the state of the art systems—“kernel”, “library”, “application package”, or having been created on request), the programmer is free to effect or otherwise such an association for each component, and to choose any desired level of privileges for the component.

It is pointed out that the term “programmer” is defined as relating to a single person or to a team of developers. A major benefit of the system according to the invention is, as will be understood, to allow teams of developers to work in the most effective manner possible, each developer being able to take responsibility for a functionality of an application, by developing a component. Also, the detailed management of privileges which is offered by the system according to the invention opens up numerous possibilities, such as for example:

the creation, the development and the complete testing of a component in “non-privileged” mode (application package), and its utilization on the target in “privileged” mode (system) once development has terminated and been fully validated. This approach allows the same flexibility of fine-tuning as a micro-kernel system, by making it possible to design a “driver” in application form, so as subsequently to utilize it at a performance level equal to a monolithic kernel, in “system” mode,

the possibility of assigning different privileges within a group of components of the same type (for example “codecs”, data coders/decoders): utilization of a simple component (example: GIF “codec”) in system component form, for speed; and of a complex component (example: HTML “codec” or Macromedia Flash (registered trade marks)) in user component form, not as fast but secure and offering complete fault tolerance.

This choice on a case by case basis allows the programmer to construct his system entirely as a function of his objectives.

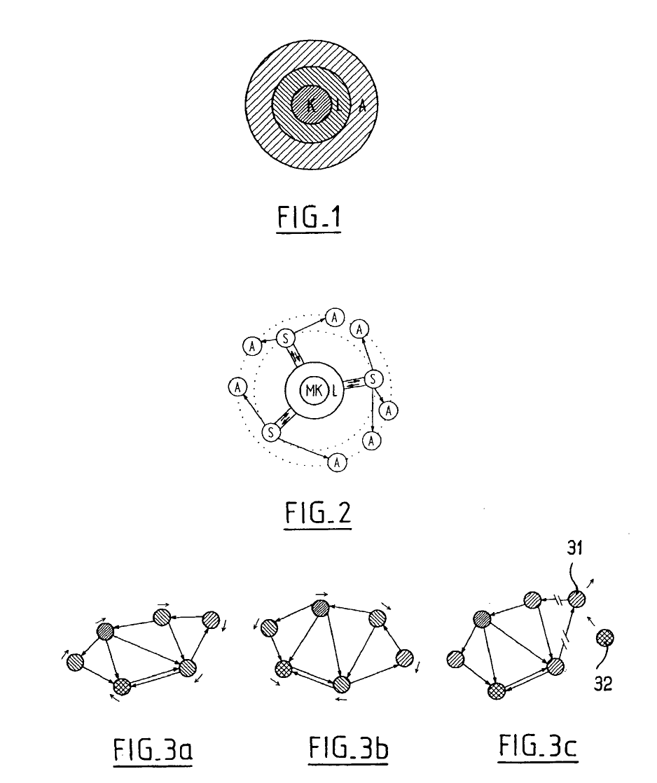

FIGS. 3a to 3c schematically illustrate the architecture of a system according to the invention, which is embodied solely on the basis of components, and which comprises no “central” element such as a kernel or a micro-kernel.

As will be seen, each of these components has its own existence in the system; they can be created, compiled, loaded into memory in the system and unloaded independently of one another, thereby making it possible to:

dynamically update the system (new version, correction of bugs, etc.) without ever rebooting,

circumvent during the design of the software system the “stances” which are rather unportable in the abstraction of the hardware by the software system, by offering the possibility of changing the hardware management policies as a function of the end product's own requirements.

Each component of the system according to the invention is dedicated to a single functionality, in contrast to conventional operation systems in which the kernel, as well as most of the programs, fulfil multiple functionalities.

Also, to fulfil the functionality associated therewith, each component can request the execution of one or more other functionality (functionalities) by one or more other component(s).

Thus, to operate, the system according to the invention places each given component loaded into its memory in communication with other components which fulfil a functionality required for the given component's own operation.

FIGS. 3a to 3c thus comprise arrows which illustrate the communication channels which are established by the system between certain components so as to allow them to transmit functionalities to one another.

These figures also illustrate the dynamic nature of the architecture of the system, it being possible for a component 31 to be replaced with a component 32 so as to fulfil the same functionality, without requiring the changing of any other component, as is represented in FIG. 3c. These aspects will be detailed hereinbelow.

The Components-General Considerations

General Definition:

It is understood that the component is a fundamental element of the system according to the invention, hence it is important to define it accurately.

A component in the sense of the invention is an isolated, independent and autonomous code element. As will be described in greater detail, each component of the system according to the invention possesses the following properties:

it fulfils a unique functionality, to which it is dedicated,

it fulfils this functionality completely. A given functionality is executed in a single component. This makes it possible not to have to modify or replace more than one component if one wishes to alter a given functionality, in the running of an application or of any other program,

just as for the object philosophy, the way in which a given functionality is fulfilled by a component is not known to the other components which use this functionality,

each component is compiled independently, so as to form a separate executable file which can be likened to a capsule of the component (referred to as a “module” of the component). During compilation, there is no editing of links between the components. This allows hitherto unknown flexibility, especially in respect of the components which fulfil the essential functionalities of the system and are allocated to the “kernel” in traditional systems,

each component is associated with an executable code encapsulated in its module with the aid of an interface which is likewise associated individually with the component. During the design of a component, the designer describes, in a text file which constitutes the source version of the interface of the component, the functionality which the component supplies, with the aid of a description language designed specially for this purpose by the Applicant. This description is the only information made available to the system with regard to the component. Such encapsulation guarantees the absence of “edge effects” and of uncontrollable interdependencies between components of the system.

A component of the system according to the invention is therefore a completely encapsulated (in the module) software object isolated from the remainder of the system with the aid of an interface, which as will be seen possesses properties:

of reusability and modularity (one and the same component can be deployed in various applications - or more generally in various programs),

of independence of the environment (each component being generated individually and being capable of being loaded and unloaded independently in the system),

of dynamic linkage (the components intervening on request, and not systematically),

and of specialization within a given functionality.

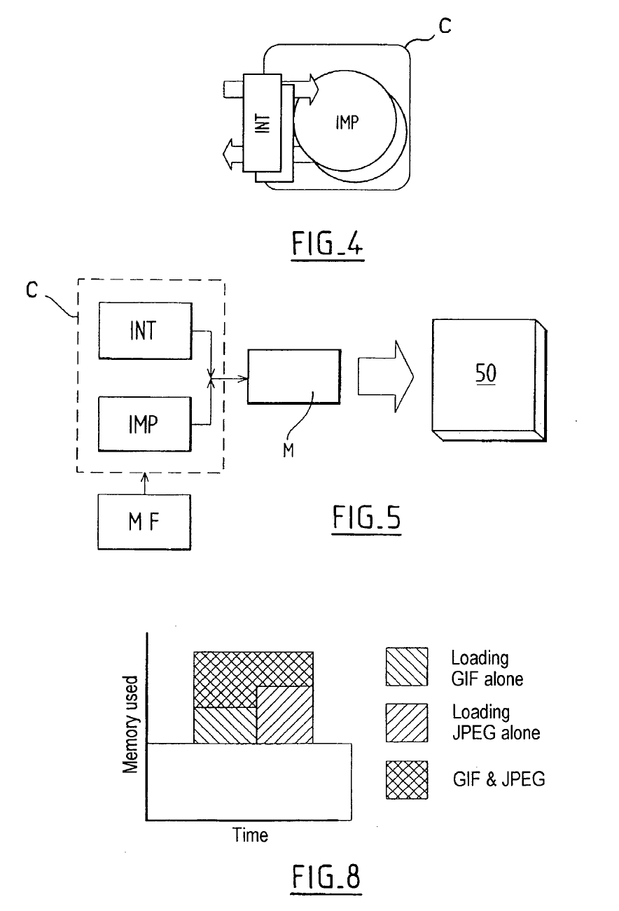

A component C consists of two main parts, as illustrated in FIG. 4:

a part IMP which allows the realization of the functionality associated with the component, which part will by convention be dubbed the “implementation part” of the component. This part corresponds to the code which is executed to fulfil the functionality of the component, and/or to a hardware implementation on hardware elements. The term “code” is understood to mean one or more programs, which may be written in any language known per se, the said program(s) being intended to fulfil the functionality associated with the component and executing one or more functions for this purpose,

and an “interface” part INT of the component, which is the descriptive part permitting dialogue with the other components of the system.

Encapsulation of the Components

Each component is encapsulated in a “module”, an executable file which links the object files corresponding to the interface and to the code of the component. As will be seen, this file is generated in an autonomous manner for each component, independently of the other components which constitute the system according to the invention.

To generate a component, it is necessary to define the functionalities external to the component and the results of which will need to be used during the execution thereof; this comes within a conventional functional analysis scheme.

On the other hand, as will be understood, the system according to the invention preserves the semantic information arising from this functional analysis phase until the realm of the execution of the component.

This greatly facilitates upgrades of the system and increases its readability.

The functionalities external to the component are described in the interface source file of the component, with the aid of the dependencies language created by the Applicant and alluded to earlier.

More precisely, each interface source file INT associated with a component C makes it possible to describe this component completely. It describes the interface elements which it has to import from other components, and those which it exports to other components.

This file will be compiled (with the aid of a compilation file MF, also called a makefile) and linked with the object file(s) corresponding to the code of the implementation part IMP (that is to say to each of the source file(s) of the implementation part of the component), to form the module M of the component which constitutes the executable version of the component, as schematically represented in FIG. 5 hereinbelow. The dependency language used to create the interface source files will be explained later in this text.

A module M can then be loaded onto a target 50 (the target being defined as the computer hardware on which the software system according to the invention operates), and be immediately recognized by the other components present on this target, as will be detailed.

The Implementation Part of the Component

The implementation part IMP is the operational core of the component. This is the part which allows the effective realization of the functionality of the component. This functionality can be realized in various ways by the implementation part, according to the functions deployed by the code.

Thus, various components can each realize one and the same functionality, whilst however taking different criteria into account, which criteria may be predetermined during the design of the application or of the program which the component is involved in, or determined dynamically during the actual execution of the application.

These criteria are described in the form of properties (for example void, char, etc.) which are associated with the interface of the component and which will be described later in this text.

The criteria are expressed as a function of one of these properties, which is defined in the interface of the component which exports the functionality, the interface of the component which imports the functionality associating a comparison operator with this property (<, >, =, etc. as described hereinbelow), as well as a comparison value.

Also, it is possible to tailor the system or the application statically or dynamically, as a function of criteria external to the component (hardware for example), or of the current state of the system and of the application during execution.

The interface file of each component thus supplies a set of meta-information which, as will be seen, will allow a specific component of the system (the dependencies manager) to manage in a relevant manner the relations between the components, as a function of the criteria alluded to earlier (which may relate to a version of the component, a location of this component, a data item of the state of the system, etc.).

It is also pointed out that if each functionality can be realized uniquely by a code (“software” implementation of the functionality), it is also possible to involve at least one hardware element to fulfil the functionality (“hardware” implementation of the functionality).

The interface part of the component

The interface part makes it possible to describe precisely which functionality is supplied by the component and which functionalities will have to be supplied to it, during its execution.

It defines, in the dependencies language developed by the Applicant, the format of the data required to be supplied as input to the component and the format of the data output by the component. This format is dependent solely on the functionality realized, and not on the way in which the functionality is realized by the implementation part.

This interface part makes it possible to construct a description of the functionality realized by the component, independently of the manner in which this functionality is realized by the implementation part. Indeed, whatever the mode of deployment of the functionality by a code (or by a programmed hardware element), this functionality remains identical. It performs the same processing operations, requests the same information at input and supplies the same data at output.

The interface part therefore amply enables upgrades of the system. A software implementation of a functionality (corresponding to a component whose implementation part consists of code) will thus be realized later by a hardware implementation.

In this case, the corresponding component comprises an interface file, but its implementation part consists of a very simple program describing the linkage with the hardware element.

Conversely, a hardware implementation may be replaced without any impact on the other components by a software implementation of a functionality.

An interface is defined with the keyword “interface” in the description of the module of the component.

The following table describes various properties of a functionality; these properties may relate to functionalities requested by the component (direction=import) or the functionality which the component supplies (direction=export):

| Property | Direction | Description |
|---|---|---|
| unique | Export | A single implementation of this |
| | | interface can exist on a local system. |
| | | The system will therefore load only |
| | | the first implementation and will |
| | | reject the subsequent ones. |
| foreign | Import | The interface is imported from another |
| | | component. |
| loadtime | Import | The interface is loaded automatically, |
| | | at the same time as the component |
| | | which uses it. |
| runtime | Import | The interface will be loaded on the |
| | | request of the component which uses it |
| | | (dynamic management - see the |
| | | paragraphs regarding the dependencies |
| | | manager) |
| required | Import | The interface is indispensable for |
| | | operation. |
| | | The component will not be loaded if |
| | | the functionality associated with this |
| | | interface is not actually imported. |
| multiple | Import | Imports all the components which |
| | | export the functionality requested by |
| | | this interface. |

An interface can be defined in its text file with the aid of various properties. An example is given hereinbelow:

inprocess supervisor module {

interface component {

/* Definition of the exported interface */

}
foreign loadtime required interface codec {

/* Definition of the imported interface */

}

};

Properties of an interface:

The properties of an interface make it possible to define the criteria alluded to earlier in this text. They are typed, as in the C language (registered trade mark). The following table describes the various types of properties:

| Property | Description |
|---|---|
| void | Void (equivalent to type C) |
| char | 8-bit integer |
| short | 16-bit integer |
| int, long | 32-bit integer |
| long long | 64-bit integer |
| float | Floating |
| double | Double (equivalent to type C) |
| struct name | Structure |
| union name | Structure |
| string | UTF-8 string terminated by a zero |
| Boolean | Boolean |
| memarea | Memory area |
| enum name | Enumeration (enum) |

The following extensions can be associated with these properties:

| Extension | Description |
|---|---|
| signed | Signed value (by default) |
| unsigned | Unsigned value |
| const | Constant value |

During the description of the dependencies in the interface file, operators make it possible to specify the properties of the interfaces. They thus make it possible to authorize the importation of another interface only if the value of a property of this other interface corresponds to a well-defined criterion.

The following operators can be associated with the properties of the interfaces:

| Operator | Description |
|---|---|
| in | This parameter is an input (by default) |
| out | This parameter is an output and will be |
| | provided by the functionality called |
| inout | This parameter is an input/output |
| = | Assignment operator |
| == | Ditto C language |
| < | Ditto C language |
| <= | Ditto C language |
| > | Ditto C language |
| >= | Ditto C language |
| != | Ditto C language |
| && | Boolean AND |
| | The result of the logical AND is |
| | different from zero |
| !& | Inverse of (&&) |
| | The result of the logical AND is zero |

The keyword “undef” can be used as comparison value for the properties or the functions. In the example hereinbelow, the component considered requires an interface named codec, containing a 32-bit integer property named mainType, whose value must be 2 exactly. This interface must ensure a functionality Func{ } taking a character string as parameter and returning a 32-bit signed integer.

foreign loadtime required interface codec {

/* Definition of the imported interface */
int mainType == 2;
int Func (string name) ! = undef;
. . .

}

The supplying and the requesting of the functionality are therefore done via the description of programming interfaces, supplied or requested. A component can for example supply the “scheduler” programming interface (the scheduler allows the creation/destruction/manipulation of procedures and of threads and their synchronization), whilst requesting the “memory” interface (memory management), the “timer” interface (management of a time counter, needed by the scheduler to interrupt a procedure after a given time and go to the next), etc.

These programming interfaces may contain both:

properties (version, type of memory management, properties of the sequencing, etc.),

and methods (functions) called up for the execution of the component.

The properties can be used both during the supplying and during the requesting of a given interface. It is therefore possible to express the fact that the memory interface associated with a component is in its version 1.5.2 thereof (property expressed during the supplying of the interface); or else the fact that there is a request for a memory interface whose version is at least 1.0.0 but not the version 1.0.4 since it is known to have an unavoidable “bug” (property expressed during the interface request).

Also, the content of the interface (properties and methods) constitutes a description written by the programmer with the aid of the language created by the Applicant for this purpose.

This language is compiled by the compiler of dependencies, in a binary form which is included within the executable component constituted by the module, in the same capacity as the code of the component and the associated data.

This binary form is easily utilizable on execution, by the system, so as to interlink the components, according to the functionalities requested.

This language is also used to specify which type of code the component contains (“system” or otherwise, “passive” (library) or “active” (application), etc.), and which type of code can access a given function (making it possible to restrict the “dangerous” functions of the system to the “system” callers for example); this makes it possible to choose the most optimized means of communication.

The Components—Creation and Loading into the System

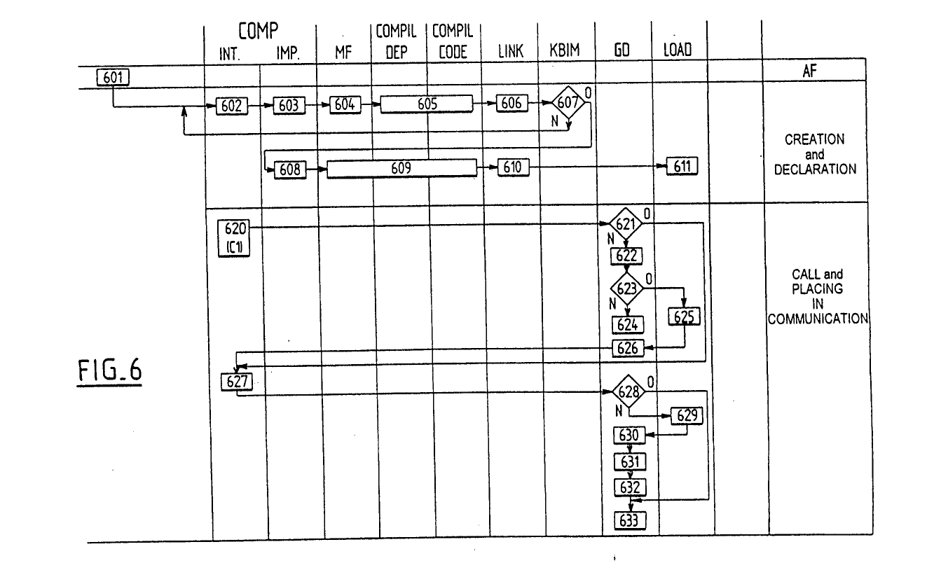

With reference now to FIG. 6, the steps of the creation of a component of the system according to the invention will now be described together with its implementation in the system according to the invention.

This FIG. 6 is a logic chart in which the columns represent various elements used for the creation and the deployment of the components of the system according to the invention. From left to right, this table is therefore made up of:

two columns “COMP” corresponding to the component itself, the leftmost column “INT” corresponding to the interface part whereas the next column “IMP” corresponds to the implementation part,

a column “MF” for the makefile which is the component compilation file,

a column “COMPIL DEP” corresponding to a components design element which is the dependencies compiler, an element specially developed by the Applicant for the compilation of a component,

a column “COMPIL CODE” corresponding to the compiler(s) of known type of the file(s) which constitutes (constitute) the code of the component,

a column “LINK” corresponding to the link editor,

a column “KBIM” corresponding to a particular development tool of the system according to the invention which comes in during the design of a project (a concept which is defined hereinafter),

a column “GD” dedicated to a particular component of the system according to the invention, dubbed the dependency manager (or GD), which as will be seen constitutes the core of the system according to the invention, but is completely different from the kernels and micro-kernels of the state of the art,

a column “LOAD” corresponding to particular components of the system according to the invention, the loaders, which make it possible to load the components of the system into a random access memory area of the target,

the right-hand column giving an indication of the various phases described.

Creation of the Component

Here we define the general concept of a “project”, which designates a set of components having a common goal in the system according to the invention. A project can thus correspond to an application, but also more generally to any type of program which can be executed by a computer system, and which differs from an application (peripherals manager for example).

Prior to the creation of a project intended to be implemented in the system according to the invention, a phase of functional analysis (AF) is carried out at 601, in a conventional manner.

This phase makes it possible to define the various components required, their respective functionalities and the needs associated with each of these functionalities (functionalities which have to be catered for by other components). It is possible, as will be seen, to use components which are already loaded into the system to afford the project certain functionalities.

Once this prior analysis has been performed, and the needs in terms of components are known, the programmer carries out for each component the succession of steps 602 to 606:

at 602, creation of an interface source file of the component in which are described, in the dependencies language developed by the Applicant, the characteristics of the component. The characteristics of this language and its main possibilities will be returned to later in this text,

at 603, the programmer then creates the code, that is to say the source file(s) making it possible to cater for the functionality of the component, in one or more language(s) which can be of known type(s). During this step, the function(s) to be exported by the component are defined only in terms of prototype, the corresponding code not being written.

It is specified that a functionality corresponds to a processing or to an operation to be undertaken (the description of a functionality will be expressed in French), for example the management of the memory, when starting up the procedures in progress so as to manage their access to the processor of the target, graphical display, etc. What we call a function is a software code part which also undertakes a processing operation. The function is the software translation into a programming language of the functionality (hence its name).

In all programming languages, a function is undertaken in very much the same way as our system. It comprises:

a prototype which defines the input and output parameters (their name and their type). This prototype can be likened to the interface part of our components (its role is identical),

a code part. This part performs a processing on data and thus makes it possible to determine the result to be supplied at output.

It is also specified that the prototype of a function defines the name of the function, its input parameters (their names and their types) as well as the type of information of the result returned by the function,

at 604, the programmer creates a makefile in which he specifies in particular:

the language(s) used for the source file(s) created during the previous step 603,

the source file(s) corresponding to the implementation part of the component,

the compilation options,

at 605, the programmer creates with the compiler of dependencies and the compiler(s) corresponding to the language(s) used a prototype of the component, comprising:

an object interface resulting from the compilation of the interface source file of the component created at 602, by the compiler of dependencies. For this compilation of the interface, the compiler of dependencies analyses the text of the source file of the interface, verifies its consistency, then translates it into binary data which will be understandable to the GD. The compiler of dependencies automatically generates files for calling the functionalities cited in the interface and which are to be supplied to the component.

These files are files of “include” type, generated by the compiler of dependencies. An “include” file is generated for each code implementation language. The role of these files is to define in the computer system a naming space (that is to say a context with which correspondences are associated), external to that of the component and distinct from it, which makes it possible to access the functionalities which are requested by the component in its interface. Each of these “include” files thus defines structures which will be able to be called up by the interface of the component, in such a way as to translate the requests made in the interface into structures and names which can be used by the implementation language with which the “include” file is associated,

an object file for each source file created at 603; at this juncture each object file corresponds to a prototype source file whose functions are not written fully,

at 606, the programmer then edits the links between the object interface and the object file(s) of the implementation part of the component, in such a way as to generate an executable component prototype.

KBIM then carries out at 607 an integrity test on the entire set of prototype components thus developed for the project envisaged, verifying that the project created is consistent and closed (that is to say that all the functionalities required for the project are present within this project).

During the integrity test, KBIM is furnished with the list and with the description of the interfaces of all the components. Thus, KBIM can search, among these components, for the component which fulfils a functionality required for the project. If several components fulfil the requested functionality, KBIM prompts the programmer to choose between these components. The component found automatically by KBIM or designated by the programmer is then added to the components which constitute the project. This new component can also require other functionalities which KBIM will attempt to resolve. KBIM thus makes it possible to automatically resolve most of the functionalities required for a project.

If the project is not correctly closed, KBIM issues an error message indicating the inconsistencies to the programmer and the latter will rerun the succession of steps 602 to 606 so as to modify certain components of the application and/or add some; if the project is consistent and closed, the programmer completes at 608 the prototypes of the functions of the code of the implementation part of the component, by writing the complete version of the functions, in the source file(s) of this implementation part.

At 609, the programmer deploys the makefile to compile each component separately, in such a way as to create for the code the object files which will make it possible to execute the functionality of the component. During this step, the makefile brings in the involvement of the dependencies compiler as well as the compiler(s) of the language(s) used to formulate the code. Steps 608 and 609 are repeated for each component of the project currently undergoing development.

At 610, the programmer then deploys the link editor to create an executable module for each component, the said module being associated with the set of object files created during the compilation steps 605 and 609 (the object interface having been created during step 605, whereas the object file(s) associated with the code was or were created during step 609).

During this link editing which corresponds to the encapsulation of the component in the module, the editor verifies that all the functionalities supplied by the various interfaces of the project have actually been described fully in an associated source file and have been compiled.

Declaration of the Component

Once an executable module has thus been created for each component of the project, the programmer must declare the existence of these components so that they are taken into account by the system. This declaration is performed at 611, during which step the programmer declares each component to a “loader”, the loaders being themselves specific components of the system according to the invention.

During this step 611, the loader to which a component is declared stores the component in an individual list of the loader which gathers together the set of components which have been declared thereto.

This step 611 is also a step which relates in an overall manner to the project currently undergoing development, the set of components developed in respect of a project being declared to at least one loader—each loader corresponding to a medium of the computer system (disk, network, etc.) on which the components associated with this loader are stored.

Loading of the Component into the System

Described hereinabove were the steps for creating and declaring a “project” which can comprise several components. Hereinbelow will now be described the deployment of these components, which is illustrated in the lower part of FIG. 6.

At 620, a component C1 calls a functionality F1 which it requires.

Two possibilities arise for this call:

either the functionality F1 is defined with the “loadtime” property in the interface of the component C1 (the “loadtime” property is described above). In this case, the GD will search for and load into the system the component which fulfils this functionality F1, prior to the loading of the component C1.

If this component itself requires a “loadtime” functionality, GD will then also load the component required to fulfil this functionality, again prior to the loading of the component C1. GD will thus recursively load all the components required to fulfil the various “loadtime” functionalities which it will encounter (how a component is loaded into the system will be explained further below),

or the functionality F1 is defined with the “runtime” property (the “runtime” property is described above). The component C1 must then make an explicit call to another functionality, “depmgr”, supplied by the GD, to call the “runtime” functionality F1. To do this, the “depmgr” functionality absolutely must be declared with the “loadtime” property in the interface of C1 so as to be able to use this interface as soon as C1 is loaded and initialized (see above the processing of the “loadtime” functionality).

C1 will then be able to import the “runtime” functionality F1 called at 620 at the precise moment at which it is to use it. The component which fulfils this functionality F1 will then be loaded by GD.

If this component requires a functionality at the moment it is loaded (functionality declared “loadtime” in its interface), the component fulfilling this “loadtime” functionality will also be loaded.

GD will thus recursively load all the components required to fulfil the various “loadtime” functionalities which it will encounter (how to load a component into the system will be explained further below). The functionality F1 requested initially at 620 will therefore be available for C1 only if all the “loadtime” functionalities encountered during its resolution are also resolved. If a single functionality requested on loading by C1 (functionality declared “loadtime”) is not resolved, C1 will not be loaded. C1 will not in fact be able to fulfil its functional mission since it will not be able to use another functionality which it requires.

If the functionality that C1 needs to import is not fulfilled by one of the components of the project to which C1 belongs and with which it is declared to one of the loaders of the system, the system, as will be seen, identifies in another project a component making it possible to supply this functionality to C1.

For these purposes GD, which is permanently loaded into the random access memory of the system, searches through its “link graph” for whether the interface object file of one of the components of the link graph indicates that this component supplies the functionality requested by C1.

To do this, the GD interprets the “binary” version of the interface file, which version is stored in the executable component, and is loaded/transmitted by the “loaders” components to the GD on execution.

The GD firstly searches for the interfaces possessing the same name as the one requested (imported). When it finds same, it then verifies within them that all the properties of the requested functionality are present and that any constraints and conditions (version higher than 0.6.2, etc.) are satisfied.

The GD link graph is a list of the components which are loaded into the system, that is to say which are not only declared as was described hereinabove with regard to step 611, but whose object interface file has been imported into a random access memory area of the target, and which is connected with other components of the link graph to exchange functionalities supplied and/or requested.

The link graph, which is stored in a random access memory area of the target, is thus an instantaneous image of the loaded components, this link graph being able to adapt dynamically. The link graph is unique and associated with the GD, the GD having access to the information of this link graph.

If during step 621 the GD determines that the functionality called up by C1 is supplied by one of the components of the link graph (which will be dubbed C2 “called component”, whilst C1 is the “calling component”), it establishes a communication channel between this component C2 and the component C1 by importing at 627 characteristics of the component C2 into the component C1.

More precisely, the GD constructs for C1 a data structure called “view” which offers a view with regard to the imports to be undertaken. This “view” contains the value of the properties as well as the pointers for the functions imported (or for the code which indirectly makes it possible to reach them, such as for example a system call, a migration of threads, etc.). This “view” emanates directly from the elements generated by the compiler of dependencies in the “include” files.

If now the GD determines at 621 that the functionality called by C1 is not supplied by any of the components of the link graph, it will interrogate the lists of the loaders of the system one after the other, so as to determine whether one of the components declared to these loaders offers the functionality requested by C1. This interrogation of the loaders is represented by step 622.

During this interrogation, the GD uses a “loader” functionality which possesses the functions required to list the components viewed by each “loader”. The “loader” functionality allows the GD to compare a functionality exported by a component of the loader, with the functionality required to be imported. It also allows the GD to load and unload an individual component, from the medium with which the loader is associated to the random access memory of the target.

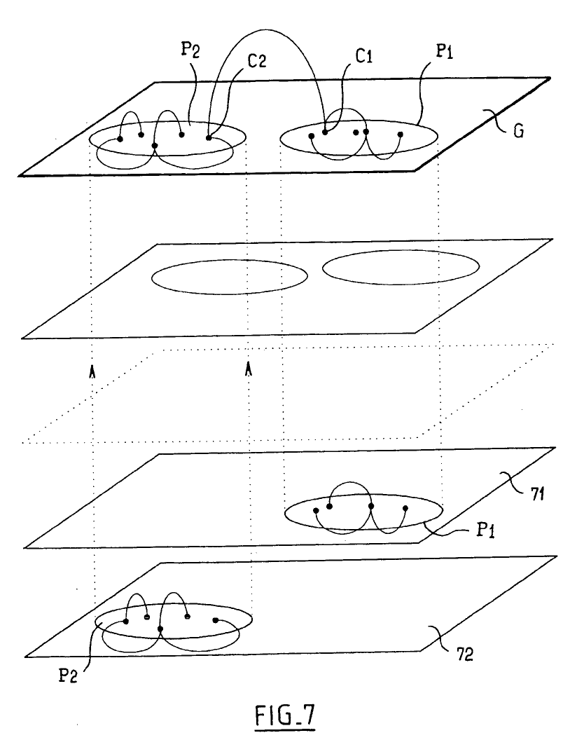

It is specified that each of the loaders of the system according to the invention is associated with a particular medium making it possible to store components; it will thus be possible for each loader to be associated with a memory disk, or with any other recording support, of CD-ROM type for example. The plurality of loaders will be illustrated in particular with reference to FIG. 7.

If such a component is located in the list of one of the loaders of the system (step 623), the first loader whose list comprises such a component transmits at 625 to the dependency manager the object interface of the component C2 identified, and the GD itself transmits at 626 the “view” of this component C2 to the component C1. (step 627).

The “view” of C2 has been stored by the GD in a system memory area which is created dynamically by the GD, upon the loading of the component C2, and which will be destroyed at the same time as this component is unloaded. This area is situated in the same address space as the component which can access it.

If now the search of the GD to identify in the list of one of the loaders a component supplying the requested functionality turns out to be fruitless during step 623, the system stops at 624.

In any event, the loading of a component C1 into the random access memory of the system brings about as explained hereinabove the automatic searching by the GD for a component C2 offering the functionality F1 which is required for the operation of the component C1.

Also, if the component C1 calls not just one but several functionalities, the GD will likewise carry out the automatic search for components offering these requested functionalities.

It will be noted that the system according to the invention offers a degree of additional flexibility as compared with the known systems.

Indeed, in the case of known systems built with entities the programmer must for each given calling entity specify the list of the other entities of the system which are required for the operation of the said calling entity, and which have to be loaded into the system for the proper operation of this calling entity.

Thus, in the case of these known systems, the needs of the entities are not generally expressed in terms of functionalities, but in terms of specific entities (such is the case for example for the Java language).

Also, in the case of the invention each of several different components is apt to be associated with a calling component C1, in so far as the said different components offer the same functionality.

Also, an additional advantage of the invention derives from the criteria which can be associated with the components, these criteria being taken into account by the GD during its automatic search for components offering a functionality requested by a first component.

Indeed, during this search for components the GD searches not only for a component offering a requested functionality, but more precisely for a component offering the said functionality in association with a specific condition expressed according to the criteria which were mentioned earlier in this text.

In the case of existing languages (for example of the type of the Java language-registered trade mark), in fact, the programmer absolutely must create an explicit link between a calling entity and a called entity.

It is thus apparent that the deployment of this type of known system does not in any way offer the same degree of flexibility as the invention, which lends itself much better to maintenance and upgrading (for example to produce enhanced versions, in which components offering a requested functionality can be replaced by other components fulfilling the same functionality in a different manner, or else new components fulfilling the said functionality can be added so as to offer new possibilities of choice to the GD.

Thus, the invention makes it possible to build extremely upgradable systems, in which just one or more desired component(s) can be replaced at will.

Each replaced component offers a functionality which was already offered by the old component which is replaced.

However, the specific means for fulfilling this functionality, be they software and/or hardware, can adapt at will.

Within the framework of applications such as the maintenance of a network of systems installed on various sites, or else the maintenance of a mobile set of devices (such as portable telephones or personal organizers for example) which one does not wish to physically return to a central site in order to upgrade them, this possibility is especially beneficial.

Thus, the applications installed on the devices of the abovementioned type can be upgraded by simply downloading one or more new component(s) onto these devices, from a central site, doing so without it being necessary to physically move the devices which can be disseminated over any territory.

Furthermore, the replacements of these components do not require the recompilation of the computer system which deploys them.

In the case where a component C2 offering the functionality requested by C1 has been identified (possibly with the criteria satisfying a condition requested by the interface of (1)) and the characteristics of C2 have been imported into C1 at 627, the dependency manager will operate differently according to whether the component C2 does or does not already form part of the link graph (step 628).

If C2 already belongs to the link graph, the GD goes directly to step 633 for creating a communication channel between C1 and C2. To do this, the system will either use one of the four communication modes described hereinbelow, or use a specific mode created specially, as a function of the characteristics specified in the interface of C1 and/or C2:

Direct Calls:

This is the fastest method. The functionality or method requested is called directly, and its result returned directly. There is no intermediate code. The dependencies manager chooses this means when the two components are on the same machine, in the same address space, and at the same level of privileges.

An address space is defined as a logical memory area in which code addresses or data addresses have a meaning for all the components accessing this area. A pointer to the code or to the data can be transmitted as is from one component to another and, without its value being modified, will make it possible to access the same data.

In the invention, the term “address space” also implies common privileges, an address space defining a “space” or a class of objects having the same level of privileges: the pointed-at objects of one and the same address space can thus be accessed in the same way by the various components.

Also, it is thus possible for example to define a “user” space with a lower level of privileges, and a “supervisor” space with a higher level.

The consistency of the pointers between the “user” space of each procedure and the “supervisor” (system) space is complied with (the processor of the computer system having access to both spaces at the same time), but the “user” code cannot reference data lying in the “supervisor” space.

The privileges are possibilities of access between components; in the source interface it is possible to use the following levels of privileges:

| Level | Description |
|---|---|
| Inprocess | The module is executed in the same address |
| | space as its calling party. |
| spawn | The component is executed in its own |
| | procedure, created during its loading. It |
| | is pointed out that when a component marked |
| | “spawn” is loaded, the GD automatically |
| | asks a “scheduler” component dedicated to |
| | scheduling to create a procedure which will |
| | be started by C1 and a corresponding |
| | address space. The component is then |
| | contained in the address space of this |
| | procedure, and operates in the guise of |
| | active element (it is possible to perform |
| | processing operations without any action |
| | other than the starting of the component), |
| | and not passive element as in the case of a |
| | component not marked “spawn” (which simply |
| | waits to be called up in order to perform a |
| | processing operation). The GD differen- |
| | tiates this level of privileges of the |
| | component before step 621. |
| To | The module performs input/output operations |
| | (driver) |
| Supervisor | The component must be executed in |
| | supervisor mode (the highest level of |
| | privileges). |

To assign one of these levels of privileges to a component, the programmer fixes the corresponding parameter in the definition of the module of the component, which definition is contained within a text of the type:

inprocess supervisor module {

/* Definition of the module */

};

Thus, in general, it is possible to associate a given level of privileges with each individual component, the said privilege level conditioning the possibilities of access of this component to other components, as a function of respective levels of privileges of the said other components.

Stated otherwise, the association of a level of privilege [lacuna] to a component gives this component the possibility of “viewing” the functionalities offered by the interfaces of certain components, as a function of the levels of privileges which are actually associated with these other components.

Also, as will be seen hereinbelow, this hierarchy of access between the components which is established by the levels of privileges which can be associated individually with the various components can be “short-circuited” by operators associated individually with certain specific components.

Examples of such calls are the following:

supervisor component to supervisor component,

user component (that is to say from the lower level of privileges) to user component in the same address space (such an application using a component managing a library of shared and passive functions).

This method is the only one employed if the memory component does not provide protection, this possibly being the choice of the engineer who constructs the system for his product, thereby providing an extremely fast system in the absence of protection.

The memory component does not “provide” protection when this component offers just a single address space, of the “system” type. This type of memory management offers no protection (everything operating within the same space and potentially being able to destroy or modify the code or the data belonging to other components), but is the only one possible on certain targets not possessing any “MMU” (memory management unit).

System Calls:

The appeal is diverted to a system call. The latter transfers the parameters from the user stack to the supervisor stack, changes level of privileges, makes the call, returns to the lower level of privileges and returns the result directly.

This method is selected when a user component (non-privileged) calls upon a functionality of a supervisor component, on condition that this functionality authorizes the non-privileged components to use it.

This authorization is made at the level of the dependencies description language, via the keyword “promote”. Also, more generally, the following keywords may be associated with a component (in the syntax of the language developed by the Applicant, the keywords are simply prefixed to the property or method whose manner of operation they are to alter):

| Keyword | Description |
|---|---|
| promote | Makes it possible to call a function |
| | implemented in a “supervisor” component from |
| | a user component. |
| untrusted | Like promote, but without automatically |
| | switching to supervisor mode. |
| async | Hands back immediately to the calling party |
| | and continues the processing of the |
| | functionality in parallel: in this case, the |
| | indirect call through the “view” ends up at |
| | code of the GD which creates a thread (which |
| | itself calls the function in question) and |
| | hands over immediately (execution continuing |
| | in the thread created). |
| serial | Calls which are concurrent with the |
| | functionality are prohibited (the other |
| | calling parties will be placed on hold). |

Thus, the authorization alluded to hereinabove, deployed via the keyword “promote” makes it possible to “short-circuit” levels of privileges which have been established elsewhere, in order to individually authorize access of one component to another, to which its level of privileges would not give it access.

Migration of Threads:

The system according to the invention separates the logical management of an execution thread (identifier, priority, system stack, etc.) from its physical management (processor context, user stack, address space in which the thread is contained, etc.).

When a component calls upon a function situated in another address space and does so synchronously (the calling party is blocked pending the result), the calling party “migrates” into the called party and performs the processing.

For this purpose, the logical part of the thread “stacks up” its current physical part, and attaches itself to a new physical part created in the address space of the called party.

The code of the desired functionality is then executed in the context of the called party (that is to say in the same address space and the same containing procedure), but in the logical thread of the calling party. Once the function has terminated, the calling thread “unstacks” its original physical part and “migrates” into the calling party again.

The threads migration code is also responsible for sending the parameters in both directions, copying or remapping the memory areas, the strings, etc. supplied as parameter.

This mechanism avoids the much more expensive traditional method consisting in composing a message, sending the message to a thread in the called component, suspending the thread of the calling party, decomposing the message in the called party, executing the desired function, recomposing a message in respect of the result, waking up the calling party, suspending the called party again.

This also avoids numerous problems related to the synchronous passing of messages, such as the reversal of priorities (here, the called functionality is executed with the priority of the calling party), the accounting of resources (the machine time is counted down at the calling party), as well as the need to maintain a “pool” of threads in the called component, which are asleep, taking unnecessary memory resources, until calls are received, subsequently being of insufficient number should there be floods of calls (here, the calling parties migrate into the called parties, there is always the exact number of threads required).

This method greatly optimizes the commonest case of calls outside of address space: synchronous calls on the same machine.

Passing of Messages:

In contradistinction to the case of micro-kernel based systems, for example, in which this method is systematically employed, it is used solely for calls which do not come within the above categories, such as:

asynchronous local call (the calling party does not remain blocked pending the result),

remote call to another machine.

The passing of messages consists in encoding the parameters supplied in a message, in routing the message to the destination component, decoding it, executing the function, storing the result in a message, returned to the calling party. This method is, as mentioned hereinabove, particularly tailored to asynchronous calls (the result message is sent later), and to remote calls, requiring the construction of network packets in any manner.

Returning to the description given with reference to FIG. 6, the creation of a communication channel is associated with the call of the function for recording the calling component C1 in the implementation part of the called component C2.

This function, dubbed Register( ), forms part of the “component” functionality which is supplied by all the components of the system, in addition to their own specific functionality. The “component” functionality comprises four functions:

initialization,

deinitialization,

recording,

derecording.

If now the GD determines at 628 that the component C2 does not form part of the link graph, at 629 it calls the loader of this component C2 so as to bring C2 into the random access memory of the target, to call at 630 the functions for initializing C2 and to update the link graph at 631.

FIG. 7 thus illustrates the link graph G, into which the GD can import a component or a set P2 of components from the memory location 72 of a first loader, so as to allow a component C1 already present in the link graph (having previously been imported from the memory area 71 of another loader with the project P1 of which it forms part) to be connected with a called component C2 which has been identified by the GD during step 623 for searching among the loaders as affording a functionality required by C1.

Indeed it is recalled that during the integrity test performed by KBIM at 607 (see FIG. 6), KBIM verifies that each functionality called by a component is offered not strictly by a component of one and the same project, but more generally by a component loaded into the software system.

Coming back again to FIG. 6, step 631 leads on to step 633 already described.

Also, whereas the loading of a component C2 called by a component C1 has been described, it is understood that the component C1 has itself been called by another component, and that it has been necessary to initiate the call of the functionalities when booting the system.

For this purpose, when starting an application, the GD requests an “interaction” functionality and searches for a component supplying this functionality. The GD can also import a component which requests this functionality. In all cases, the “interaction” functionality will call another component, which in turn will call at least one other component.

The Dependencies Manager

It has been stated that the dependencies manager is a component permanently loaded into the system according to the invention. It makes it possible to construct the links between the various components which constitute an application; these links are established from the interfaces of the components.

According to an advantageous aspect of the invention, only those components which are useful in respect of the operation of the application and of the system will be loaded, thus optimizing the resources required. This optimization can be achieved according to one of the following modes:

Automatic Loading of Components During Execution

When a component is loaded so as to be executed, the dependencies manager analyses its dependencies as expressed in its interface and automatically seeks to resolve all the dependencies expressed therein, that is to say to supply the component with all the functionalities which it needs, and also to “close” the system of dependencies by likewise seeking to supply every component thus deployed with the functionalities which it needs.

The GD then automatically loads into the link graph the components resolving the interfaces imported whose property is “loadtime”, also resolves their dependencies and creates the communication channels between these various components, as a function of their respective locations.

A communication channel can thus be created according to any mode of communication as defined above; it consists of any data transmission pathway (specific to each mode of communication) capable of calling a functionality with the associated parameters, and of recovering the return value(s) resulting from the processing performed by the functionality.

As soon as the communication channels are created, the components can communicate directly with one another.

Dynamic Loading and Unloading of Components:

When an imported interface has the “runtime” property, the component which uses this interface will request the loading of the component which implements this interface, only when this component needs the functionality associated with the interface. This “runtime” property is thus an alternative to the “loadtime” property already described.

This management makes it possible to accurately determine the properties of the implementation of the interface which has to be loaded, as a function of dynamic parameters, which are not known when loading the component requesting the functionality.

For example, a “text” component can import a codec interface so as to decompress the files which it receives, this “text” component being able to receive several types of files.

During reception of a file, the “text” component can search for the codec interface tailored to the decompression of this file, as a function of its extension for example. To do this, it uses the Query( ) functionality of the dependencies manager, passing the search parameters to it.

It can then order the dependencies manager, with the aid of the Open( ) functionality, to load the component. It can then use the codec interface of this component to decompress the file.

When the decompression has terminated, the “text” component can request the unloading of the codec component used.

It is thus possible to load a component dynamically. This possibility allows components to be loaded only when they are required to perform a processing. The component can then be unloaded when its processing has terminated.

According to another example, an application can display an image during its loading and subsequently no longer have to process images of this format, or process them only exceptionally.

This application can therefore dynamically load the component for processing the image format, requesting it to process the file so as to display the image and subsequently unload this component. The component is loaded into memory only when it is strictly required, this making it possible to share the memory resources among the various components, as a function of processing operations to be undertaken at a given instant.

This method therefore allows a considerable reduction in the memory resources required.

The dependencies manager can also automatically manage the loading and unloading of components as a function of their usage statistics and memory resources. This management then becomes completely transparent to the programmer of the application.

The diagram of FIG. 8 shows the benefit of dynamic management of the components on a system possessing few memory resources. In this example, the application displays two images, a GIF and a JPEG. Each image is processed sequentially, thereby making it possible to load and unload the components dynamically.

In this example, the dynamic loading and unloading of the components makes it possible to reduce the maximum memory resource required.

Furthermore, in most cases, this loading and unloading will not be perceptible in terms of performance.

Indeed, the modules of components have a reduced size (of the order of a few hundred bytes to a few kilobytes). The operation of loading them into memory is therefore one which is carried out very fast. Furthermore, most of the applications perform sequential processing operations and the input information is often supplied by a human user and the output information are supplied to the user.

Hence, on the human scale, the few micro-seconds which will be required to load and unload a component will not even be perceptible; in the case of the example illustrated by FIG. 8, the operations are carried out according to the following sequence:

loading of an image (loading of the JPEG code),

displaying of this image on the screen,

the user,

loading of another image (unloading of the JPEG code and unloading of the GIF code),

displaying of this other image.

The loading and unloading time is insignificant compared with the other processing operations.

Optimization of Resources by the Dependencies Manager:

The dependencies manager manages a usage counter for each component. This counter counts the number of “importers” of the component, that is to say of components which import a functionality from the component with which the counter is associated. A component is unloaded as soon as its usage counter has decreased to 0.

When a component is no longer used, the dependencies manager automatically frees the resources used for this component.

It will be noted that the invention thus allows particularly effective optimization of the resources deployed by the system, without burdening the general manner of operation of the system.

Indeed, the known systems generally deploy periodic means for verifying the state of the components, the said means being deployed by a specific task which “takes over” periodically so as to identify the components which have to be unloaded.

Such a periodic verification task is not well suited to real time, since it does not enable the modifications of state of the components to be tracked with good reactivity.

Moreover, a manner of operation of this type demands a multitask environment owing to the presence of the verification task.

An illustration of a manner of operation of this type deploying periodic verification will be found in the Java language, the verification task deploying an element of the “garbage collector” type.

Details Regarding the Functionalities Undertaken by a Hardware Element:

It has been stated that the implementation part of a component could correspond to a code (which comprises one or more programs so as to fulfil the functionality of the component), but also to a hardware implementation based on hardware elements comprising electronic circuits.

Thus, a functionality can be undertaken by a component C1 which implements it by using an electronic circuit (video decompression circuit for example). However, this functionality can also be undertaken by a component C1 which implements it on the basis of software alone. If for an application the electronic circuit is indeed present and operating correctly, the system will use the component C1. If, on the other hand, the electronic circuit is not present or if it is not operating correctly, the system will use the component C1′, in a manner which is transparent to the other components. In all cases, the functionality is undertaken.

Likewise, if a functionality is undertaken today by software code, it may be undertaken later by a component which implements it using an electronic circuit, in a manner which is completely transparent to the other components.

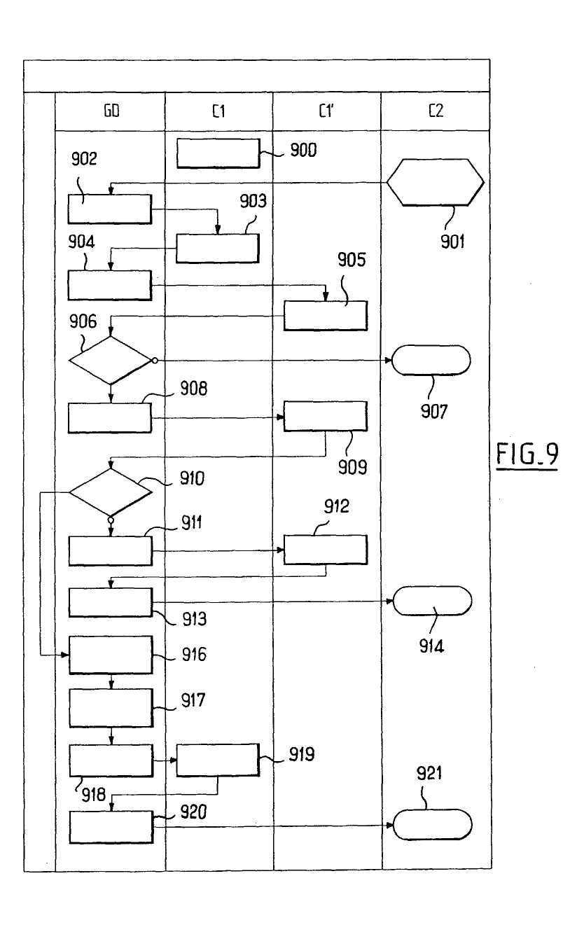

The diagram of FIG. 9 illustrates the replacing of a component C1 by another component, C′1, which exports the same functionality.

C1 currently executing as indicated at 900, a component C2 which possesses a channel for communication with C1 and is thus linked to it in the link graph requests the GD at 901 for the replacement of C1 by C′1.

GD then requests C1 to save its current state (step 902), this being undertaken by C1 at 903. GD then loads and initializes C′1 (904 and 905).

If the loading or the initialization of C′1 are not performed correctly (step 906), the GD returns an error to the requester C2.

If the loading and the initialization of C′1 took place correctly, the GD transmits at 908 the current state of C1 to C′1, so that C′1 places itself in the same state.

For these purposes, C′1 interprets the current state transmitted (909) and accepts it or rejects it (910).

If it rejects it, the GD unloads C′1 (911) and deinitializes it (912). The GD then returns an error message to the requester C2 (913 and 914).

If now C′1 accepts the current state of C1, the GD updates its graph (916) by replacing C1 with C′1 therein. It then reconstructs the communication channels for C′1 (917); these channels are those which were used for C1. Then the GD deinitializes and unloads C1 (918 and 919).

The replacement having been performed correctly, GD informs C2 thereof (920, 921); the latter can continue its processing.

Described hereinabove was the principle of the system according to the invention, and the application thereof (among other things with reference to FIG. 6).

Let us specify that it is also possible to parameterize the interface of the component C1 so that, when the GD searches for a component which exports a functionality imported by C1, it continues its search among the set of components loaded into the system and transmits to C1 a “view” of each of the components of the link graph which exports this functionality, in a step equivalent to step 627 of FIG. 6.

As a function of the parameterized selection criteria, C1 will then be able to select the appropriate component for it from among those identified by the GD.

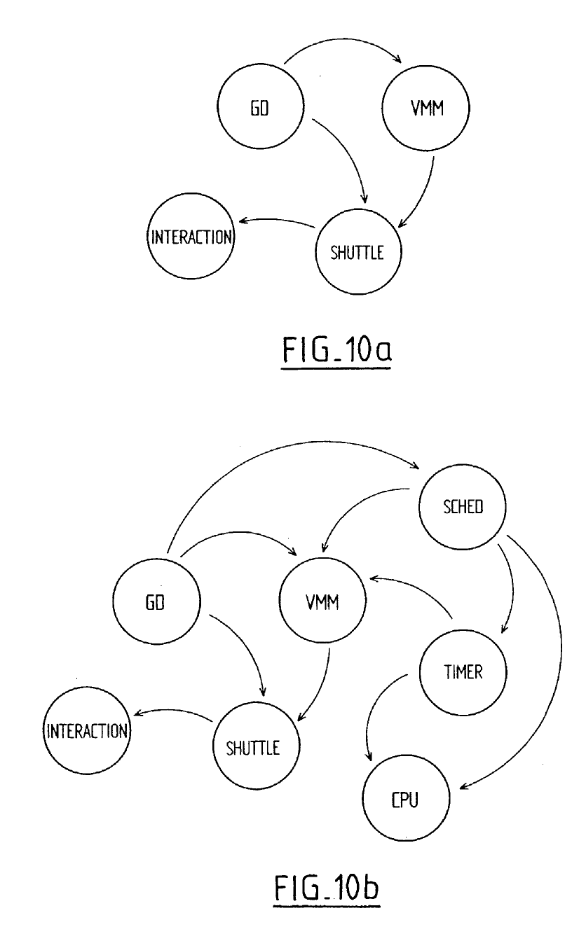

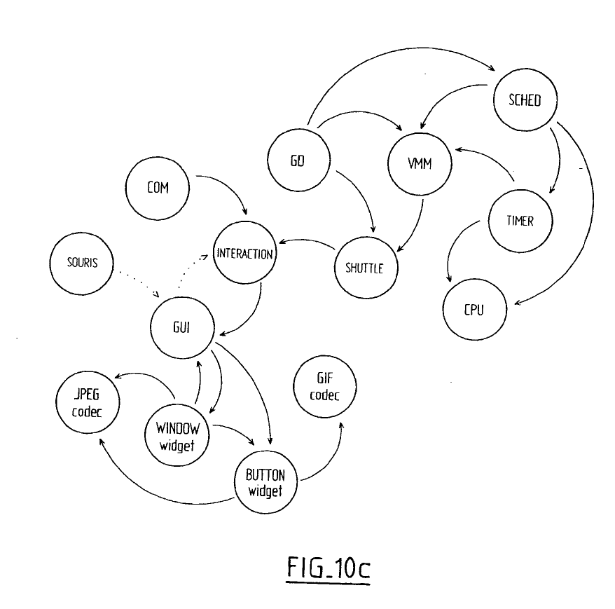

Let us also specify that, in its current version, the system according to the invention requires a minimum of four components to operate, as represented in FIG. 10a (in which the arrows indicate the functionalities transmitted between components—this type of figure is thus a representation of the link graph).

These are the following components:

“interaction” which as has been stated is required in order to initiate the operation of the system,

“shuttle” which is called by “interaction” and which itself calls the following two components:

the GD,

and finally “VMM”, the so-called memory component or memory management component which also calls the GD as well.

FIG. 10b shows a likewise minimal configuration of the system, in which three components “CPU”, “TIMER3” and “SCHED” have been added so as to permit multi-thread management.

Finally, FIG. 10c represents an enhanced configuration of a system according to the invention, which constitutes a small application.

In this figure, the “interaction” component uses a “COM” component for communication so as to exchange data over a network and uses the “GUI” (graphics interface) component to display graphical presentations.

The “MOUSE” component makes it possible to manage the MOUSE peripheral. It transmits information regarding the changes of state of this peripheral (move, click on the buttons). The “GUI” component uses the “WINDOW” and “BUTTON” components to carry out the displays requested by the “INTERACTION” component.

The “WINDOW” and “BUTTON” components use the GIF and JPEG codec components to display images in their respective display areas.

The GUI, COM, WINDOW, BUTTON, GIF and JPEG components also use functionalities of the basic components of the system. However, the links corresponding to these functionalities are not represented in the diagram of FIG. 10c so as not to overburden this figure.

The components are classed into domains, which are categories not corresponding to a level of privileges, but to a type of use. Various domains are as follows, with certain associated components:

| Domain | Description |
|---|---|
| SHEDULE | Scheduler components |

MULTILEVEL

| | |
|---|---|
| GESTION MEMOIRE | Memory management components |

VMM
LMM

| | |
|---|---|
| BUS | Bus management components |

ISA
PCI

| | |
|---|---|
| COMM | Communication components |

ETHERNET
FTP
IPSTACK
SERIAL

| | |
|---|---|
| INPUT | Input systems management components |

ELOTOUCH (touch-sensitive panel)
KEYMAP
PCKBD
PS2MOUSE (PS2 mouse)
REBOOT (watchdog)

| | |
|---|---|
| GFX | Graphics interface management components |

GFX
BUTTON
WINDOW
SCROLLBAR
TEXT
IMAGE

| | |
|---|---|
| SON | AUDIO management components |

AUDIO codec

| | |
|---|---|
| IMAGES | Image and video management components |

JPEG codec
GIF codec
PNG codec
BMP codec
MPEG codec

| | |
|---|---|
| FILE SYSTEM (FS) | Disk management components |

FAT
HDD
CD

It will be noted that because all the components of the system according to the invention are realized according to the same format, the system manages all the components in the same way and the abovementioned advantageous properties of the components apply in the same way to the components, regardless of their level of privileges.

Lastly, it is apparent that the system according to the invention makes it possible:

for programmers to have an overview of all the elements of the operating system, regardless of their level of privileges,

to use the same tools to create these various elements,

to effect interconnections between the various parts, without restriction. The power of the system is not expressed by its number of components, but the number of possible interconnections, in the traditional systems (both monolithic and micro-kernel), the means of communication between the various parts are limited and fixed. It is systematically necessary to go via an arbitrary bottleneck (the system calls being limited in number, for the kernel, whether this be a monolithic kernel or a micro-kernel, etc.). Management of dependencies and dynamic creation of communication means makes it possible to overcome this limitation,

to offer equal properties to all the code types. In the case of the invention, it is in fact no longer necessary to design a system for managing kernel modules, libraries, or even “plug-ins” of applications. All this is replaced by the components management system,

to create as many components, in the future, as functionalities which will need to be fulfilled. This allows the system according to the invention to be completely upgradable.

Furthermore, as has been seen in the description hereinabove, the invention shows a great readability and a reactivity to the developer, by returning error messages in many instances.

Indeed, during the loading of the component, a function (Init) is automatically executed for this component. This function (Init) verifies that the set of components required for the operation of the loaded component is actually loaded into the system. In the case where this verification is not satisfactory (at least one requested functionality is not fulfilled, or else a component offering a requested functionality is associated with a defective hardware element, etc., an error message is returned to the calling party.

Furthermore, in the case where a called component is associated with a defective element (hardware and/or software), it is automatically unloaded into the random access memory of the system.

Additionally, it was seen with reference to FIG. 9 that error messages were also returned when components were called.

Thus, if a hardware or software element is absent or defective with regard to operating a calling component, an error message keeps one advised thereof without requiring a complete operation of tests of the system.

1. Process for developing computer projects (P1, P2) intended to be implemented by a computer system, process comprising a phase of functional analysis (601) with a view to cataloguing the functionalities which are to be catered for, a phase of creating components (C1, C2) of the project with the aid of computer means so as to fulfil the said functionalities, a phase of declaration on the same system of the components created during the creation phase, and a phase of loading the said components into a memory area of the system for their implementation by the system, characterized in that:
during the components creation phase, each functionality is completely fulfilled by the component associated therewith,
during the components declaration phase, each component created is declared to a system loading component, and
during the components loading phase, there are provided means (GD) for, in association with each functionality requested by a loaded component, automatically searching for a component offering the said functionality.

2. Process according to the preceding claim, characterized in that the said automatic search is performed while taking a condition into account.

3. Process according to the preceding claim, characterized in that the said condition is expressed as a function of criteria expressed as a function of properties associated individually with each component.

4. Process according to one of the preceding claims, characterized in that during the creation of a component, the following steps are carried out:
creation (602) of an interface source file of the component, with a view to constituting an “interface” part (INT) of the component,
creation (603) of at least one code source file making it possible to realize the functionality of the component, with a view to constituting an “implementation” part (IMP) of the component.

5. Process according to the preceding claim, characterized in that each code source file created with a view to constituting an “implementation” part of the component can be formulated in any programming language.

6. Process according to one of the preceding two claims, characterized in that each component can fulfil the functionality associated therewith by deploying software and/or hardware means.

7. Process according to one of the preceding four claims, characterized in that the interface file of each component comprises a description of the functionality fulfilled by the said component, independent of the manner in which this functionality is fulfilled by the component.

8. Process according to the preceding claim, characterized in that the interface file also comprises a description of the functionalities that the component needs to import from other components in order to fulfil its own functionality.

9. Process according to one of the preceding claims, characterized in that each component (C1) can be dynamically replaced by another component (C′1) which exports the same functionality.

10. Process according to the preceding claim, characterized in that the said replacement deploys the following steps:
saving of the current state of the component to be replaced,
loading and initialization of the new component,
transmission of the current state of the component to be replaced to the new component,
establishment of a communication channel between the component calling the functionality and the new component,
unloading of the component to be replaced.

11. Process according to the preceding claim, characterized in that if the loading or the initialization of the new component is not performed correctly, means are provided for returning an error message.

12. Process according to one of the preceding four claims, characterized in that during the creation of a component, the following steps are also carried out:
creation (604) of a makefile in which are specified:
the language(s) used for the source file(s) created during the code source file(s) creation step,
the code source file(s) corresponding to the “implementation” part of the component, creation (605) of a prototype of the component,
editing of links (606) between the “interface” part and the “implementation” part of the component, so as to generate an executable component prototype,
deployment of the makefile (609) so as to compile the component individually, and constitute a respective object file for the interface source file of the “interface” part of the component as well as for the or each code source file of the “implementation” part of the component,
encapsulation (610) of the object files created during the preceding step into a single executable module.

13. Process according to the preceding claim, characterized in that during the creation of the prototype of a component, a prototype comprising:
an object interface resulting from the compilation of the interface source file of the component,
a prototype object file in respect of each code source file of the “implementation” part of the component, is created.

14. Process according to the preceding claim, characterized in that during the compilation of the interface source file of the component, there is carried out:
the analysis and the verification of the consistency of the source file of the interface,
the translation of the source file of the interface into binary data,
the automatic generation of at least one file so as to call the functionalities which are to be imported by the component.

15. Process according to one of the preceding three claims, characterized in that after the step of editing links between the “interface” part and the “implementation” part of the component so as to generate an executable component prototype, an automatic integrity testing step (607) is carried out during which one verifies whether the project is consistent and closed.

16. Process according to the preceding claim, characterized in that during the automatic integrity test, for each functionality required in the project, there is an automatic search, from among a list of accessible components, for a component which fulfils the said functionality.

17. Process according to the preceding claim, characterized in that in the case where several components fulfilling the requested functionality are identified, a particular component can be chosen from among these components.

18. Process according to one of the preceding two claims, characterized in that in the case where the integrity test reveals that the project is not correctly closed, an error message is issued indicating the inconsistencies so as to be able to modify certain components and/or add some.

19. Process according to one of the preceding seven claims, characterized in that for each component loaded into the system, the description of the functionalities that the component needs to import from other components so as to fulfil its own functionality is permanently accessible to the said means (GD) of automatic component search.

20. Process according to one of the preceding eight claims, characterized in that during the encapsulation (610) of the object files created during the preceding step into a single executable module, one verifies that all the functionalities supplied by the various interface parts of the project have actually been described fully in an associated source file and have been compiled.

21. Process according to one of the preceding nine claims, characterized in that the process comprises the storage in a random access memory area of the system of a map (G) of the components loaded into the system.

22. Process according to the preceding claim, characterized in that the said map is intended to be consulted when a calling component calls a functionality, so as to determine whether a component of the said map is able to supply the functionality called up.

23. Process according to the preceding claim, characterized in that it is the said means (GD) of automatic component search which are able to consult the said map.

24. Process according to one of the preceding three claims, characterized in that the said map is updated in real time during the operation of the system, as a function of the components loaded into the system.

25. Process according to one of the preceding claims, characterized in that each component can be associated with a level of privileges which conditions the possibilities of access of the component to other components, as a function of the respective levels of privileges of the said other components.

26. Process according to one of the preceding claims, characterized in that means are provided for automatically unloading each component where the functionality which it offers' is no longer necessary for the operation of the computer projects.

27. Process according to the preceding claim, characterized in that the said means comprise a usage counter for each component.

28. Process according to the preceding claim, characterized in that the said counter counts the number of components which import a functionality of the component with which the counter is associated, and the said component is unloaded as soon as its usage counter has decreased to zero.

29. Process according to the preceding claim, characterized in that there are provided means (GD) for automatically freeing the resources used by the said unloaded component.
